(19) United States
(12) Patent Application Publication
(10) Pub. No.: US 2007/0053333 A1
(43) Pub. Date: Mar. 8, 2007

(54) Method and apparatus for sharing desired information among wireless transmit/receive units

(75) Inventor: Ravikumar V. Pragada, Collegeville, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/264,330

(22) Filed: Oct. 31, 2005

Related U.S. Application Data
(60) Provisional application No. 60/715,242, filed on Sep. 8, 2005.

(51) Int. Cl. H04Q 7/24

(52) U.S. Cl. 370/338

(57) ABSTRACT

A method and apparatus for sharing information among a plurality of wireless transmit/receive units (WTRUs) in a wireless communication system comprises a first WTRU in the wireless communication system broadcasting a request for desired information. A second WTRU in the wireless communication system searches a memory of the second WTRU for the desired information and responds to the broadcast by indicating to the first WTRU that it is capable of providing the desired information. The first WTRU requests that the second WTRU provide the desired information, and the second WTRU retrieves the desired information from the memory in the second WTRU and sends the desired information to the first WTRU.

### CROSS REFERENCED TO RELATED APPLICATIONS

This application claims the benefit of U.S. Provisional Application No. 60/715,242, filed on Sep. 8, 2005, which is incorporated by reference herein as if fully set forth.

### FIELD OF INVENTION

The present invention is related to accessing information in a wireless communication system. More particularly, the present invention relates to a method and apparatus for sharing desired information among wireless transmit/receive units.

### BACKGROUND

Information has rapidly become the lifeblood of modern society. Major decisions, both business and personal, are often based on the possession of timely information, such as when to sell a particular stock on the market, or which route to work should be taken by a driver of a vehicle. In many cases, users access this information by accessing it from the Internet. In fact, many people now possess wireless transmit/receive units (WTRUs), such as personal data assistants (PDAs) or cellular phones which often are equipped with the ability to access and share information over a network such as the Internet. Given the large memory capacities of these mobile devices and the ability to interface large numbers of them together to share, and/or store information, these devices may be referred to as infinite storage devices.

To provide access to information, particularly through the Internet, some municipalities, among other entities, have created public hot zones. These hot zones evolved from “hot spots” such as that which exist in a traditional wireless network. Hot spots are geographical regions which provide a wireless connection point between the Internet and WTRUs. For example, a hot zone may be created by wireless router or base station connected to an Internet modem. The hot zones can be defined by an area in which wireless connection is available to a WTRU. Within each hot zone, a wireless connection device, such as a wireless router, wireless base station, or the like, provides a wireless access point (AP) for the WTRU to access the wireless network created by the hot zones. Antennas may be included in each hot zone to facilitate communication between each hot zone. Thus, the wireless connection devices coupled to the antennas permit WTRUs in a particular hot zone to access other hot zones. A Wireless Internet Service Provider (WISP) can be the hot spot through which the Internet can be accessed from any of the hot zones.

An alternative to the traditional hot zone-based network is an Ad-hoc or mesh network. These networks have the capability to allow neighborhood users to directly link their networks together in order to permit faster file and packet sharing and also to facilitate Internet access.

In a rudimentary form, an Ad-hoc or mesh network is formed by networking devices together and allowing data shared between the devices. With technologies such as Wireless Local Area Network (WLAN), Ultra Wide Band (UWB), Bluetooth and the like, Ad-hoc or mesh networking becomes even more effective since devices do not need to be physically connected to one another. A user who wishes to connect his device to an Ad-hoc or mesh network simply needs to have a wireless connection adapter in the applicable device to connect to any available wireless networks either directly or through another device. Often, one or more of these short-range technologies is integrated within a WTRU. These wireless networks can be a community-based mesh network, or any Ad-hoc network in the vicinity of the user. For example, an Ad-hoc network could be formed on a mass transit vehicle to support a plurality of WTRUs.

An advantage of Ad-hoc or mesh networks is that, with the introduction of IEEE 802.11n standards and UWB, effective data rates of 100 Mbps or more are possible. Since the end user data rates for cable and digital subscriber links (DSL) can be much lower than this, faster sharing of information is possible over these mesh-networks if the desired information is locally available in the mesh-network, rather than going to the Internet to obtain the desired information. This is particularly useful when no connection or a reliable to the Internet is not available, such as when traveling in a mass transit vehicle. If there are multiple storage devices in the vicinity, such as within the mass-transit vehicle, it is possible that the information the user is interested in may be public information resident on local devices. As will be described hereinafter, this information can be extracted by an application installed on a user's device.

The community-based mesh network can include a plurality of nodes, of which one can be a user node. The community-based mesh network can also include an Internet AP, which is connected to the Internet. In this way, the plurality of nodes can connect to the Internet via the Internet access point, and each node does not require its own Internet gateway.

When a connection to the Internet is not available, such as when a user may be in a mass transit vehicle, static web information can still be exchanged between nodes or users in a given hot zone or region where an Ad-hoc or mesh network is formed. Among other advantages, this also opens up opportunities for community-based mesh networks to exchange information that is locally available without having to procure information for external sources, thereby, saving time and cost.

Currently, there is no method or apparatus that allows a WTRU to first determine if the information its user desires is available with other WTRUs in the local network, such as in an Ad-hoc or mesh network, prior to seeking it on the Internet, and to select a particular device from which to receive the desired information based upon a pre-selected criteria. It would therefore be beneficial if a method and apparatus existed that could allow a WTRU to first seek information that a user desires on a local Ad-hoc or mesh network, and to select a particular device from which to receive the desired information based upon a pre-selected criteria. It would further be beneficial if the application could operate either in configuration with a user's existing web browser or independent of the user's web browser.

### SUMMARY

A method and apparatus for sharing information among a plurality of wireless transmit/receive units (WTRUs) in a wireless communication system comprises a first WTRU in the wireless communication system broadcasting a request for desired information. A second WTRU in the wireless communication system searches a memory of the second WTRU for the desired information and responds to the broadcast by indicating to the first WTRU that it is capable of providing the desired information. The first WTRU requests that the second WTRU provide the desired information, and the second WTRU retrieves the desired information from the memory in the second WTRU and sends the desired information to the first WTRU.

### BRIEF DESCRIPTION OF THE DRAWINGS

The foregoing summary, as well as the following detailed description of the preferred embodiments of the present invention will be better understood when read with reference to the appended drawings, wherein:

FIG. 1 shows a wireless communication system configured in accordance with the present invention;

FIG. 2 shows a block diagram of a pair of WTRUs configured to perform a method for sharing desired information in the wireless communication system of FIG. 1, in accordance with the present invention;

FIG. 3 shows a signal diagram of the pair of WTRUs shown in FIG. 2 performing the method for sharing desired information in the wireless communication system of FIG. 1; and

FIG. 4 is a flow diagram of a method for sharing desired information in the wireless communication system of FIG. 1.

### DETAILED DESCRIPTION OF THE PREFERRED EMBODIMENTS

Hereafter, the terminology “WTRU” includes, but is not limited to, a user equipment (UE), a computer, a mobile station, a fixed or mobile subscriber unit, a pager, or any other type of device capable of operating in a wireless environment. It is to be noted that a WTRU is not only capable of wireless communication with other WTRUs, but is also capable of wired communication with other devices, including other WTRUs.

By utilizing the nearly infinite memory on WTRUs, it is possible to store most web pages that the WTRUs have accessed over time. These web pages can be accessed manually, that is, by a user requesting the web page at a particular time, or by an automatic download setting on the WTRU. One such example of this might be a really simple syndication (RSS) web page that tracks websites and is updated with any content from the websites without the user having to actually connect to the web server to extract those updates. The user can configure a RSS such that a WTRU periodically downloads the information and/or data from websites selected by the user.

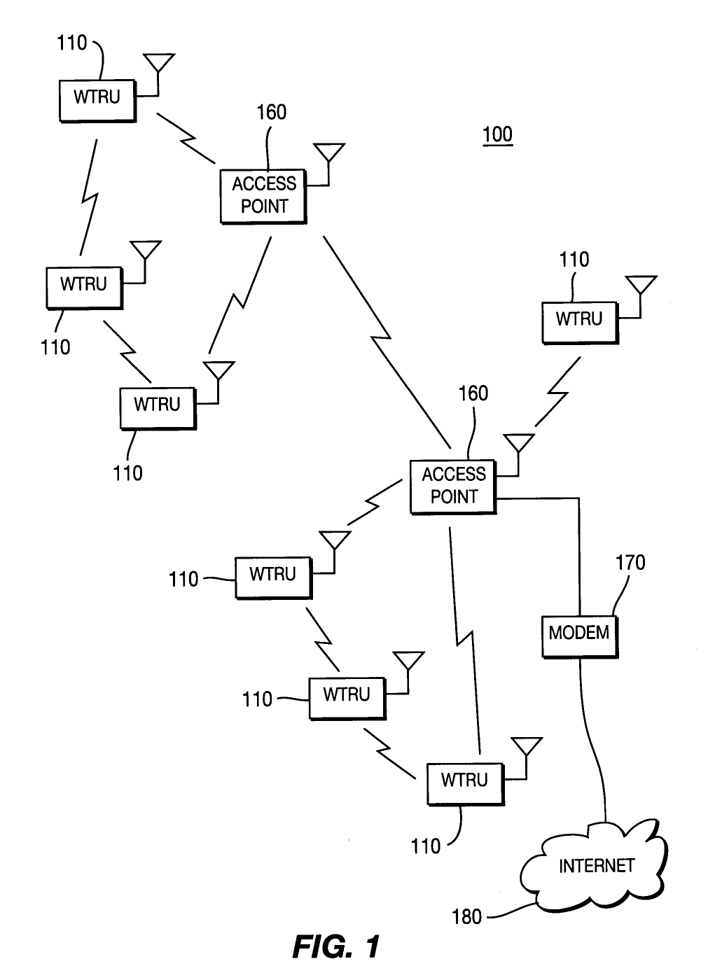

FIG. 1 is a wireless communication system 100 configured in accordance with the present invention. The wireless communication system 100 includes a plurality of WTRUs 110, and a plurality of access points 160, in communication with one another to form an Ad-hoc/mesh network. In a preferred embodiment of the present invention, the WTRUs 110 are in wireless communication with one another and the access points 160. Alternatively though, any number of the WTRUs 110 can be physically connected to any of the access points 160 or to one another. In addition, at least one of the access points 160 can be connected to a modem 170 for connection to the world wide web (WWW) via the Internet 180.

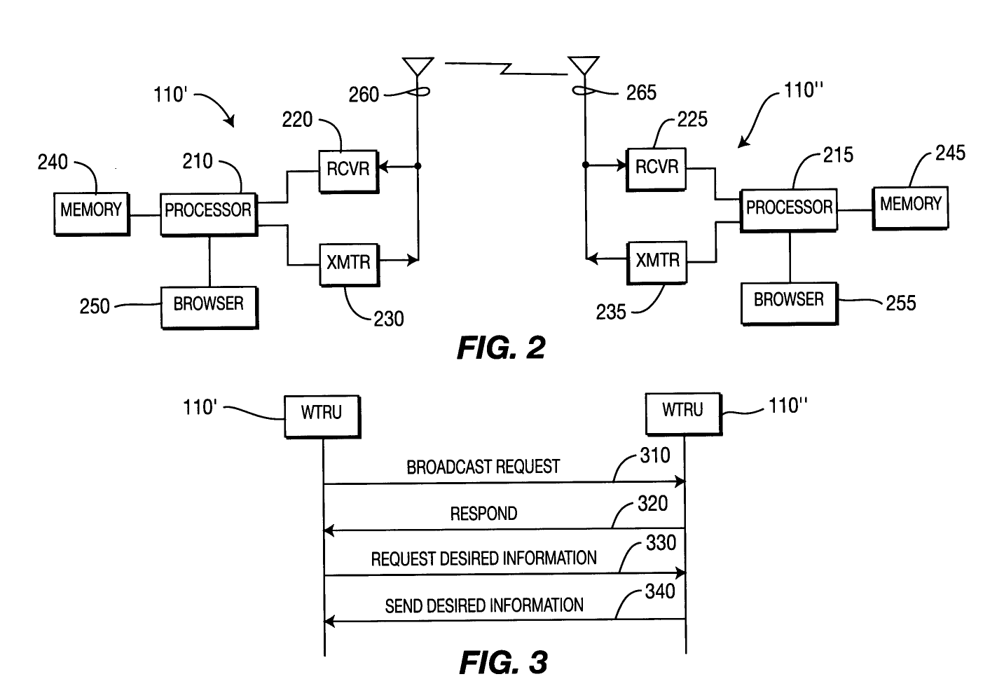

FIG. 2 shows a block diagram of a pair of WTRUs 110 (referenced as 110′ and 110″), configured to share the desired information in the wireless communication system 100, in accordance with the present invention. For purposes of example, The WTRU 110′ and the WTRU 110″ are substantially similar units, however, WTRU 110′ is shown operating as a first WTRU requesting desired information while WTRU 110″ is shown operating as a particular WTRU that might contain the desired information requested by WTRU 110′.

In addition to the nominal components included in a typical WTRU, the WTRU 110′ includes a processor 210 configured to process requests for desired information by the user of the WTRU 110′, a receiver 220 in electrical communication with the processor 210, a transmitter 230 in electrical communication with the processor 210, a memory 240 in electrical communication with the processor 210, and an antenna 260 in electrical communication with both the receiver 220 and the transmitter 230 to facilitate transmitting and receiving wireless information. In a preferred embodiment of the present invention, a browser 250 such as Microsoft® Internet Explorer or the like may be included to interface with the processor 210.

In addition to the nominal components included in a typical WTRU, the WTRU 110″, similar to the WTRU 110′, includes a processor 215 configured to process the transmission and reception of requests for desired information received from the WTRU 110′, a receiver 225 in electrical communication with the processor 215, a transmitter 235 in electrical communication with the processor 215, a memory 245 in electrical communication with the processor 215, and an antenna 265 in electrical communication with both the receiver 225 and the transmitter 235 to facilitate transmitting and receiving wireless information. In a preferred embodiment of the present invention, a browser 255 such as Microsoft® Internet Explorer or the like may be included to interface with the processor 215.

FIG. 3 shows a signal diagram between the WTRU 110′ and the WTRU 110″ during a request for desired information by the user of the WTRU 110′. Although a more detailed method of requesting desired information will be described below, in general, the processor 210 of the WTRU 110′ receives a request for desired information and broadcasts the request (310) to the WTRU 110″ via the transmitter 230 and the antenna 260 of the WTRU 110′. The receiver 225 of the WTRU 110″ receives the broadcast request through the antenna 265 and transfers the broadcast request to the processor 215 of the WTRU 110″. The processor 215 searches the memory 245 of the WTRU 110″ to determine if the desired information is stored in the memory 245.

If the desired information is contained in the memory 245 of the WTRU 110″, then the processor 215 of the WTRU 110″ transmits a response (320) to the WTRU 110′ through the transmitter 235 and antenna 265 of the WTRU 110″. In a preferred embodiment of the present invention, the response includes data about the desired information, such as a time stamp on the desired information. The receiver 220 of the WTRU 110′ receives the response through the antenna 260 and transmits it to the processor 210 for processing.

Upon receiving the response (320), the processor 210, utilizing a pre-selected criteria which will be described in detail below, determines whether the user would want to request the desired information from the WTRU 110″. If the processor 210 determines that the user would want to request the desired information from the WTRU 110″, then the processor 210 requests that the desired information be sent (330) via the transmitter 230 and the antenna 260 of the WTRU 110′.

The receiver 225 of the WTRU 110″ receives the request that the desired information be sent (330) through the antenna 265, and transmits it to the processor 215. The processor 215 then extracts the desired information from the memory 245 on the WTRU 110″ and sends the desired information (340) back to the WTRU 110′ through the transmitter 235 and antenna 265 of the WTRU 110″.

The receiver 220 of the WTRU 110′ receives the desired information through the antenna 260 of the WTRU 110′ and transmits it to the processor 210 which stores the desired information in the memory 240 of the WTRU 110′. In a preferred embodiment of the present invention, the desired information stored in the memory 240 may be viewed by the user of the WTRU 110′ with the browser 250.

By virtue of the wireless communication system 100 being an Ad-hoc network, any of the WTRUs 110 may be able to connect to the Internet 180. Additionally, although in a preferred embodiment of the present invention the predominant network is a wireless network, it can be seen by one of ordinary skill in the art that the wireless communication system 100 could employ wired components as well as wireless components.

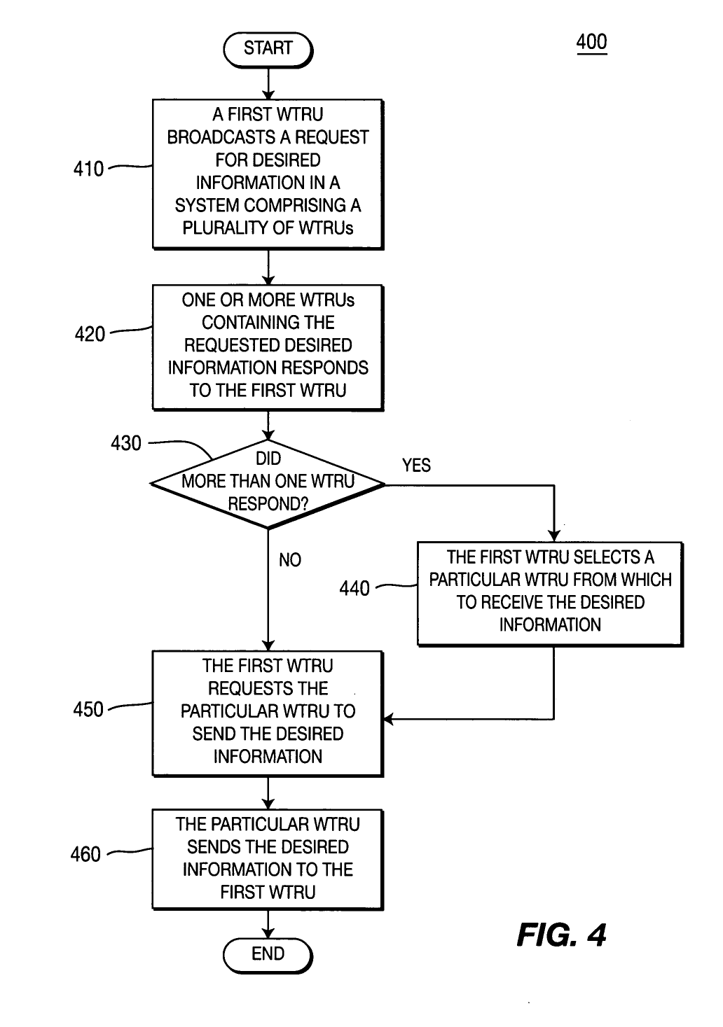

FIG. 4 is a flow diagram of a preferred method 400 for sharing desired information among WTRUs in a wireless communication system. In step 410, the first WTRU 110′ broadcasts a request for a particular web-page or desired information to the plurality of WTRUs 110 in the system 100.

One or more particular WTRUs 110″ in the system 100 that contain the desired information in their memory respond back to the first WTRU 110′ (step 420). If more than one WTRUs 110″ contain the desired information, multiple responses are received by the first WTRU 110′ (step 430). The first WTRU 110′ then determines from which particular WTRU 110″ to request the desired information (step 440) based upon the pre-selected criteria by the user. By way of example, the first WTRU 110′ may select the particular WTRU 110″ that responds first, the particular WTRU 110″ which contains the most recent desired information as indicated on a time stamp on the desired information, or the particular WTRU 110″ that is the least number of hops from the first WTRU 110′. It is noted that the pre-selected criteria may take into consideration a plurality of these factors wherein the factors may be weighted as desired. For example, the pre-selected criteria may be such that a first factor in selecting a particular WTRU 110″ is based upon which particular WTRU 110″ has the most recently time stamped information. However, if more than one particular WTRU 110″ contains similarly time stamped information, then the first WTRU 110′ may select the particular WTRU 110″ that is the least amount of hops from the first WTRU 110′ as a second factor. It can therefore be seen by one of ordinary skill in the art that any combination of factors may be weighted to comprise the pre-selected criteria by which the first WTRU 110′ selects the particular WTRU 110″ from which to receive the desired information.

In step 450, the first WTRU 110′ requests that the particular WTRU 110″ send the desired information, and once the first WTRU 110′ and the particular WTRU 110″ agree on exchanging the desired information, the desired information is sent (step 460) from the particular WTRU 110″ to the first WTRU 110′.

At this point, if a time stamp is associated with the desired information exchanged between the particular WTRU 110″ and the first WTRU 110′, and the user desires information that is dated later than that indicated by the time stamp, the user can obtain the updated information from what was received from server device if an Internet connection is available.

One example of how the method 400 may be implemented could be to have a user solicit information from other WTRUs 110 to see what kind of information they might have on a particular topic. For instance, the user may broadcast a request to see what kinds of newspapers any of the other WTRUs 110 have available. The other WTRUs 110 in the wireless communication system 100 would then respond to the request, informing the user as to the kinds of newspapers stored in their memory. If the user likes any of the information he has seen, he can request that particular desired information from that particular WTRU 110.

In a preferred embodiment of the present invention, the processor 210 of the WTRU 110′ is configured to query other WTRUs in the system 100 to determine if they have the desired information that the user desires already stored in their memory by way of a software application. This can be done in several ways. In one embodiment, the application is a programmable option to the existing browser 250 on the WTRU 110′ to obtain the web-page information from other WTRUs 110 before resorting to seeking the information on the Internet. For example, the application can take the form of a plug-in program for the existing browser 250 that seeks the information a user requests from other WTRUs in the wireless communication system 100 to which the WTRU device 110′ is communicating with.

In another embodiment, the application is a separate application that operates independently of the existing browser 250 on the WTRU 110′. In this embodiment, the application runs in the processor 210 on the WTRU 110′ without needing access to the browser 250 installed on the WTRU 110′. The application is run at the request of the user to attempt to obtain the web-page information from other WTRUs 110 in the system 100 that the user has requested. Alternatively, the application is similar to a typical RSS reader installed on a WTRU to read RSS pages.

An advantage of the present invention is that WTRUs 110 having hard-disks or other storage devices can act as web-proxies. Instead of each individual user having an Internet connection, these web-proxies can connect to the Internet to extract information, and each user can wirelessly connect to the web-proxies, effectively creating a wireless local area network (WLAN) among the community of users. The users in this community can collectively maintain these WLAN devices, and request what kind of information they would like to have stored on them. The WLAN devices can then obtain this information for the community of users, by way of their Internet connection. Everyone in the community can utilize this information without all individually having to connect to the Internet and, as a result, save bandwidth. A more sophisticated version of the WLAN devices could include creating a virtually library of information that can be shared among the community of users.

In a preferred embodiment of the present invention, the WTRUs can operate on their own power, typically by a battery. However, power and battery consumption can be alleviated by having external power sources available to the WTRUs forming the wireless communication system. For example, in wireless communication system formed on a mass transit vehicle, external power receptacles can be provided at seats for a user to power his WTRU and join the wireless communication system. Any way known to one of ordinary skill in the art of externally powering a user's WTRU may be employed, however. Additionally, the WTRU includes a user setting to disable the processor from receiving incoming broadcasts and requests. In this way, the WTRU conserves battery power as well as provides the user with an opportunity to secure the WTRU from another WTRU.

It should be noted that in a preferred embodiment of the present invention, the WTRUs are in wireless communication with one another via radio frequency signal. However, any wireless communication method known to one of ordinary skill in the art may be utilized for the WTRUs to communicate with one another, such as infrared communication, microwave communication, and the like. Additionally, in a preferred embodiment of the present invention, the method for acquiring desired information from WTRUs in a wireless communication system is described as an application run on a processor contained within the WTRU, it can also be implemented by means of an integrated circuit within the WTRU processor, or any other means of implementation known to one of ordinary skill in the art.

The present invention is applicable to the application layer of wireless systems; and may be implemented as software or middleware.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for sharing information among a plurality of wireless transmit/receive units (WTRUs) in a wireless communication system, comprising:
a first WTRU in the wireless communication system broadcasting a request for desired information;
a second WTRU in the wireless communication system searching a memory of the second WTRU for the desired information; and
the second WTRU responding to the broadcast by indicating to the first WTRU that it is capable of providing the desired information.

2. The method of claim 1, further comprising:
the first WTRU requesting that the second WTRU provide the desired information; and
the second WTRU retrieving the desired information from the memory in the second WTRU and sending the desired information to the first WTRU.

3. The method of claim 1, further comprising the second WTRU sending data about the desired information to the first WTRU.

4. The method of claim 3, wherein the data about the desired information includes a time stamp on the desired information.

5. The method of claim 4, further comprising other WTRUs in the wireless communication network indicating to the first WTRU that they are capable of providing the desired information.

6. The method of claim 5, further comprising the other WTRUs sending data about the desired information to the first WTRU.

7. The method of claim 6, wherein the data about the desired information includes a time stamp on the desired information.

8. The method of claim 7, further comprising the first WTRU selecting a particular one of the WTRUs from which to receive the desired information.

9. The method of claim 8, wherein the particular WTRU is the first WTRU that conveys its capability to provide the desired information.

10. The method of claim 8, wherein the first WTRU selects a particular WTRU that is the least number of hops away from the first WTRU.

11. The method of claim 8, wherein the particular WTRU contains the most recent time stamp.

12. The method of claim 8, further comprising:
the first WTRU requesting that the particular WTRU provide the desired information; and
the particular WTRU retrieving the desired information from the memory in the particular WTRU and sending the desired information to the first WTRU.

13. In a wireless communication system comprising a plurality of wireless transmit/receive units (WTRUs), each WTRU comprising:
a transmitter;
a receiver; and
a processor in communication with the transmitter and the receiver, wherein an application for sharing information with other ones of the WTRUs in the wireless communication system runs on the processor, the transmitter broadcasts a request for desired information, the receiver receives a first signal from a particular one of the other WTRUs indicating that the particular WTRU is capable of providing the desired information, the transmitter requests the particular WTRU to provide the desired information, and the receiver receiving the desired information from the particular WTRU.

14. The WTRU of claim 13, wherein each WTRU further comprises a memory in communication with the processor.

15. The WTRU of claim 14, wherein the desired information is stored in the memory.

16. The WTRU of claim 13, wherein each WTRU further comprises an antenna in communication with the transmitter and the receiver.

17. The WTRU of claim 13, further comprising a browser in communication with the processor.

18. The WTRU of claim 17, wherein the application for sharing information runs on the processor as a plug in application to the browser.

19. In a wireless communication system comprising a plurality of wireless transmit/receive units (WTRUs), each WTRU including an integrated circuit (IC) comprising:
a transmitter;
a receiver; and
a processor in communication with the transmitter and the receiver, wherein an application for sharing information with other ones of the WTRUs in the wireless communication system runs on the processor, the transmitter broadcasts a request for desired information, the receiver receives a first signal from a particular one of the other WTRUs indicating that the particular WTRU is capable of providing the desired information, the transmitter requests the particular WTRU to provide the desired information, and the receiver receiving the desired information from the particular WTRU.

20. The IC of claim 19, further comprising a memory in communication with the processor.

21. The IC of claim 20, wherein the desired information is stored in the memory.

22. The IC of claim 19, further comprising an antenna in communication with the transmitter and the receiver.

23. The IC of claim 19, further comprising a browser in communication with the processor.
